(19) United States
(12) Patent Application Publication
(10) Pub. No.: US 2006/0012836 A1
(43) Pub. Date: Jan. 19, 2006

(54) Focus adjustment for imaging applications

(76) Inventor: Christian Boemler, Meridian, ID (US)

Correspondence Address: DICKSTEIN SHAPIRO MORIN & OSHINSKY LLP, 2101 L STREET, NW, WASHINGTON, DC, 20037, US

(21) Appl. No.: 10/892,312

(22) Filed: Jul. 16, 2004

(51) Int. Cl. H04N 1/04

(52) U.S. Cl. 358/474

(57) ABSTRACT

An image sensor unit is coupled to at least one moveable element, for example at least one piezoelectric material, for automatic or manual focus adjustment. The position of the image sensor unit can be selectively adjusted by manually or automatically changing at least a position of at least one moveable element such that a change in the position of the image sensor unit effects a desired focus of an image.

### FIELD OF THE INVENTION

The present invention relates to focus adjustment for imaging applications.

### BACKGROUND OF THE INVENTION

As pixel arrays of imaging equipment decrease in size and focal lengths become smaller, there is need to improve focus adjustment. Conventional applications use a fixed focus, where objects close to the lens appear blurry or have an actuator to adjust the focal distance.

Other conventional applications perform focusing manually or automatically by moving the lens and lensmount via an actuator, but this has disadvantages for small handheld devices where the lens is exposed to the user and the actuator can be destroyed by pressure. Modern handheld devices often use smaller focal distances, and the focus needs to have less adjustment range.

Referring to FIG. 1, a conventional fixed focus lens 70 is shown in cross-sectional view. Sensor module 16, formed over substrate 10, comprises an image sensor 24 formed as a pixel array over an attachment layer 30. Incoming light 40 is focused by fixed focus lens 70. FIG. 1 schematically shows lens 70 mounted in lens mount 72 in a fixed position over module 16.

The conventional fixed focus lens system 20 shown in FIG. 1 has a fixed position relative to sensor module 16. There is a fixed focal length (f₀) from lens 70 to focal point 28, where f₀ is the distance from L1 to L2. The fixed position of lens 70 places a limit on the distance of objects that are in focus. For example, light from objects that are either nearer or farther from lens system 20 will not be in focus because of the corresponding change in focal length.

Referring to FIG. 2, a conventional manually or automatically adjustable focus lens system 120, comprising adjustable focus lens 170, is shown in cross-sectional view. Sensor module 116, formed over substrate 110, comprises image sensor 124 formed as a pixel array over attachment layer 130. Incoming light 140 is focused by lens 170. Focal length (f₁) is the distance from lens 170 to focal point 128, or the distance from M1 to M2, when lens 170 is at position B. Focal length f₁ may change, as lens 170 is adjusted to bring each image into focus. For example, as shown in FIG. 2, manual or automatic adjustment of lens 170 from position A to position B will change f₁. Lens 170 may be adjusted to adjust the focus by operation of an actuated lens mount 150. However, lens assembly 120 is subject to damage because actuated lens mount 150, lens 170, and other components of assembly 120 may be damaged during use.

Given the disadvantages of conventional image focusing techniques, it would be advantageous to improve focus techniques for imaging applications.

### BRIEF SUMMARY OF THE INVENTION

The present invention provides exemplary embodiments in which automatic or manual focus of an image is performed.

In exemplary embodiments an image sensor is attached to an element having a changeable position for automatic or manual focus adjustment. The position of an image sensor can be selectively adjusted by, for example, changing the position of the element which changes the sensor position as needed or desired by, for example, regulating a bias voltage. The bias voltage may be regulated manually or by one or more autofocus algorithms, whereby the system can perform image focus while maintaining a fixed-position lens mount.

In a preferred embodiment, the changeable dimension element is a piezoelectric material which may be attached to a fabricated image sensor, or can be fabricated at the wafer level as part of the image sensor.

These and other features and advantages of the invention will be more apparent from the following detailed description that is provided in connection with the accompanying drawings which describe and illustrate exemplary embodiments of the invention.

### BRIEF DESCRIPTION OF THE DRAWINGS

FIG. 1 depicts a cross-sectional view of a conventional fixed focus lens assembly;

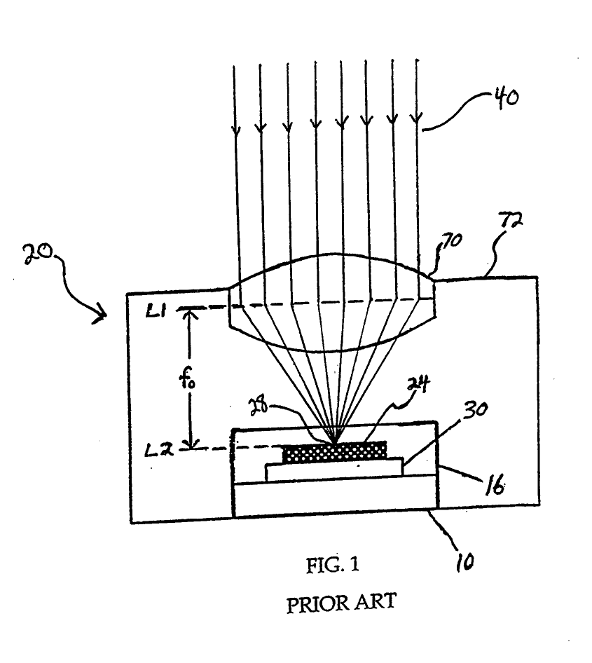

FIG. 2 depicts a cross-sectional view of a conventional adjustable focus lens assembly;

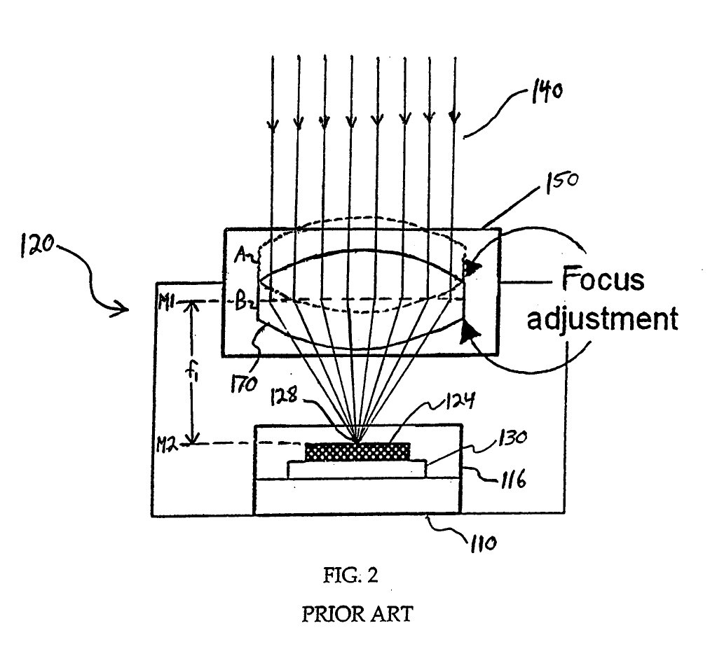

FIG. 3A is a cross-sectional view of an adjustable focus lens assembly in accordance with one embodiment of the invention;

FIG. 3B depicts an intermediate stage of processing of an image sensor and moveable element in accordance with one embodiment of the invention;

FIG. 4A is a flowchart of an automatic focus operation in accordance with an exemplary embodiment of the invention;

FIG. 4B is a flowchart of a manual focus operation in accordance with an exemplary embodiment of the invention;

FIG. 5 is a block diagram of an imaging apparatus that performs automatic focus in accordance with one embodiment of the invention; and

FIG. 6 is a schematic block diagram of a processing system that includes an imaging apparatus as in FIG. 5.

### DETAILED DESCRIPTION OF THE INVENTION

In the following detailed description, reference is made to various specific embodiments in which the invention may be practiced. These embodiments are described with sufficient detail to enable those skilled in the art to practice the invention, and it is to be understood that other embodiments may be employed, and that structural and logical changes may be made without departing from the spirit or scope of the present invention.

Exemplary embodiments of the invention obtain automatic or manual focus adjustment for an image by selectively changing a sensor position in accordance with changes in one or more dimensions of an element in response to an applied voltage. For example, a piezoelectric material may be attached to a sensor such that the sensor position is adjusted as needed or desired by adjusting a voltage applied continuously or incrementally to the piezoelectric material.

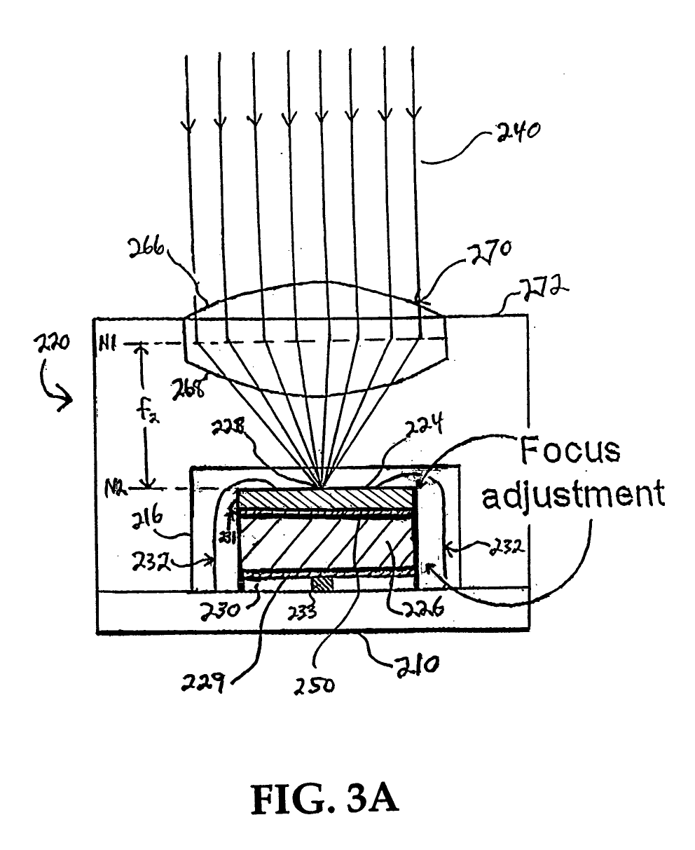

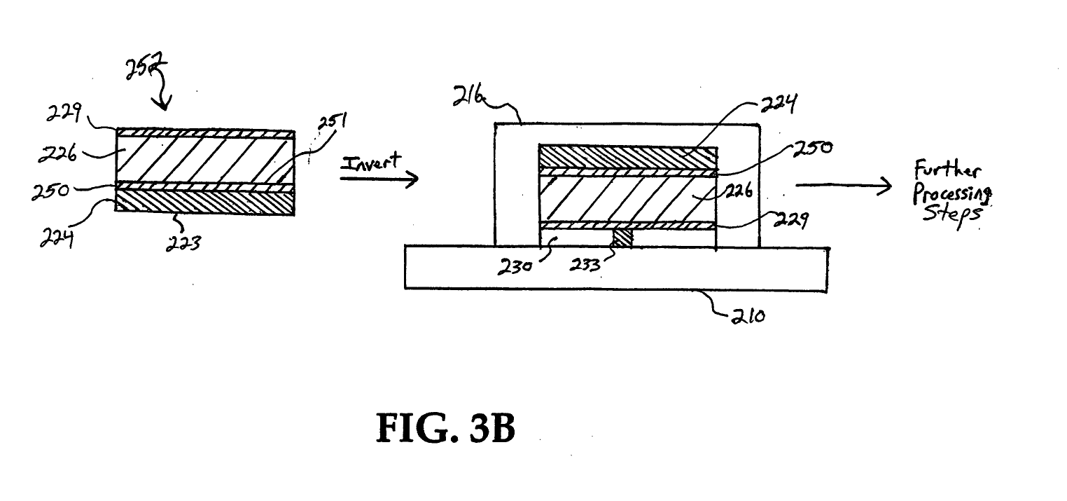

Referring to FIG. 3A, one exemplary embodiment of the invention is shown in which lens assembly 220 (in cross-sectional view) comprises fixed focus lens 270 mounted in lens mount 272 above sensor module 216. Sensor module 216 is formed over housing base 210. Image sensor 224, which has a pixel array, is mounted within sensor module 216 to piezoelectric material 226. Piezoelectric material 226 may be mounted over, or formed upon, conductor 229 which in turn is mounted to base 210 through attachment layer 230. Another conductor 250 is mounted to piezoelectric material 226 between material 226 and sensor 224. Conductive element 233 couples conductor 229 to conductors provided on an upper surface of base 210.

As shown in FIG. 3A, a voltage source for applying the voltage across the piezoelectric material 226 may be obtained from the image sensor 224. Alternatively, the control voltage applied across piezoelectric material 226 may be obtained from another source. If the piezoelectric control voltage is supplied by image sensor 224, bonding wires 231, 232 may be utilized which respectively couple a voltage output from image sensor 224 to conductive layer 250 directly and 229 indirectly through the conductive trace on base 210 and conductive element 233. Bonding wires 231, 232 may be adjusted to accommodate changes in thickness of the piezoelectric material 226 which occur during a manual or automatic focus adjustment. The invention may include other devices to compensate for stressing of wires 231, 232 during a manual or autofocus operation.

Automatic or manual focus adjustment of the invention is achieved by changing the thickness of piezoelectric material 226 in a continuous or non-continuous, e.g. stepped, manner under control of a continuous or stepped voltage applied to conductive layers 229, 250.

Piezoelectric material 226 may comprise one or more types of piezoelectric material, for example piezoelectric ceramic material, which may be arranged in any number and orientation. For example, a plurality of piezoelectric materials may be arranged in a stacked manner to obtain a desired thickness or, alternatively, in a series such that each of the plurality of piezoelectric materials is aligned along a generally horizontal plane.

In other embodiments of the invention, sensor 224 may be operably mounted within sensor module 216 to any other material, device or mechanism, which can change a position of sensor 224 in response to an applied changeable voltage, such that an automatic or manual focus adjustment may occur. The changeable voltage may come from sensor 224 itself or a separate external circuit.

In the FIG. 3A embodiment, incoming light 240 is focused by an adjustable focus lens 270, shown as a generally double convex lens with an upper surface 266 and a lower surface 268. Alternatively, lens 270 may be formed of any material and shape that operates to substantially form an image by focusing rays of light, for example. Lens 270 may be formed as a substantially transparent material with upper surface 266 and lower surface 268. Surfaces 266 and 268 may each be formed in any shape, including but not limited to curved or planar shapes. For example, surfaces 266 and 268 may each be convex, thus forming a biconvex optical lens as shown in FIG. 3A. Alternatively, surfaces 266 and 268 may be shaped to form a generally spherical lens. In addition, lens 270 may be used in combination with at least one or more other optical instruments or lenses to form an image upon image sensor 224.

In addition, although only one lens 270 is depicted in FIG. 3A, any combination of two or more lenses may also be used in the present invention. In addition, lens 270 may be formed of any suitable material, including but not limited to glass, plastic, or any other substance, whether natural, synthetic or a combination or composite thereof. The lens or lenses of the invention may be used to focus light or other electromagnetic radiation of any wavelength, in forming an image upon image sensor 224.

If lens 270 is formed having spherical surfaces, the focal distance may vary for different rays and thus produce spherical aberration (not shown). In addition, the focal length for different wavelengths may also differ and produce chromatic aberration (not shown). Nonetheless, the manual or autofocus operation of the invention, by employing, for example, a piezoelectric material biasing provides the capacity to automatically or manually correct for such aberrations and produce the desired focus of an image.

In the embodiment illustrated in FIG. 3A, a piezoelectric material 226 is formed over conductor 229 which in turn is mounted to base 210 through attachment layer 230. Another conductor 250 is formed over piezoelectric material 226, and a die containing a pixel array, forming image sensor 224, is mounted to conductor 250.

In accordance with another embodiment of the invention, as shown at an intermediate stage of processing depicted in FIG. 3B, a conductor 250 is formed over a backside of an image sensor 224 die, wherein surface 223 of sensor 224 functions as the upper surface of the sensor. Piezoelectric material 226 is formed at the wafer level on the backside 251 of conductor 250. Another conductor 229 is then formed over piezoelectric material 226. The image sensing unit 252 is then positioned by inverting the unit 252, as shown in FIG. 3B, to an upright position with sensor 224 positioned over piezoelectric material 226. The unit 252 may then be subject to further processing steps as needed or desired.

According to one exemplary embodiment, the thickness of piezoelectric material 226 may be changed by regulating the bias voltage to change the thickness of piezoelectric material 226 by approximately 0.3 microns per applied volt, though the amount of thickness change per applied volt is dependent on the size and shape and other physical properties of the piezoelectric material 226.

The bias voltage may be regulated manually or based on one or more autofocus algorithms, for example based on regional entropy maximization, whereby the system can perform image focus. For manual focus, an operator may select a bias voltage using either a continuous or stepped bias voltage value.

Autofocus algorithms for use in the invention may operate by any known autofocus technique, for example according to regional entropy maximization or other entropy focus criteria. In some circumstances,, algorithms based on minimizing the Renyi entropy of an image may be used, utilizing one or more contrast-enhancement criteria. In other circumstances, autofocus algorithms for the automatic correction of motion artifacts or blurring in images may be employed. In yet other circumstances, autofocus algorithms may be utilized that adjust the focus of an image according to the degree of contrast detected between adjacent pixels. For example, a greater degree of contrast may correspond to, and thus be interpreted as, a greater degree of focus of the image. By regulating the bias voltage across a piezoelectric material, based on one or more autofocus algorithms, the system can perform autofocus while maintaining a fixed-position lens mount. In addition, the autofocus algorithms used in the invention may be used in conjunction with signal-processor-based acquisition systems for further image correction, focus and enhancement.

Image sensor 224 may be, for example, a CMOS image sensor comprising a focal plane array of pixel cells, each one of the cells including either a photogate, photoconductor, or photodiode overlying a charge accumulation region for accumulating photo-generated charge. The active elements of a pixel cell may perform photon to charge conversion; accumulation of image charge; transfer of charge to a floating diffusion node accompanied by charge amplification; resetting the floating diffusion node to a known state before the transfer of charge to it; selection of a pixel for readout; and output and amplification of a signal representing pixel charge.

Although one exemplary embodiment of the invention is shown in FIG. 3, and described above, those skilled in the art will recognize that the invention encompasses any type of image sensor having a pixel array, and that substitutions, additions, deletions, modifications and/or other changes may be made to the exemplary embodiment without departing from the spirit or scope of the invention. For example, image sensor 224 may be employed in any number of different types of semiconductor-based imagers, including for example charge coupled devices (CCDs), photo diode arrays, charge injection devices and hybrid focal plane arrays.

The invention may be employed in many digital applications such as, for example, cameras, scanners, machine vision systems, vehicle navigation systems, video telephones, computer input devices, surveillance systems, star trackers, motion detection systems, and image stabilization systems.

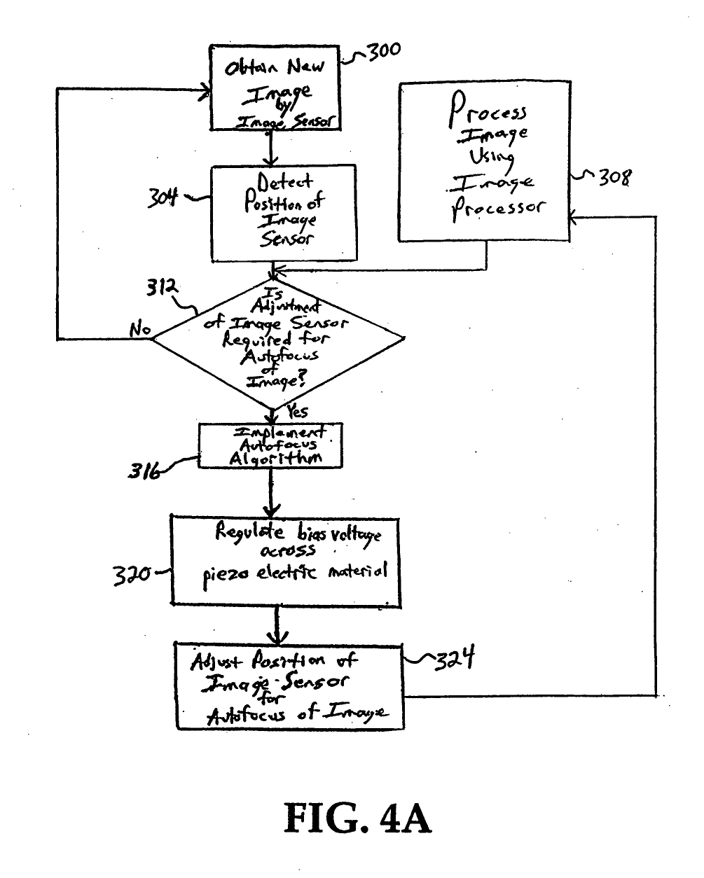

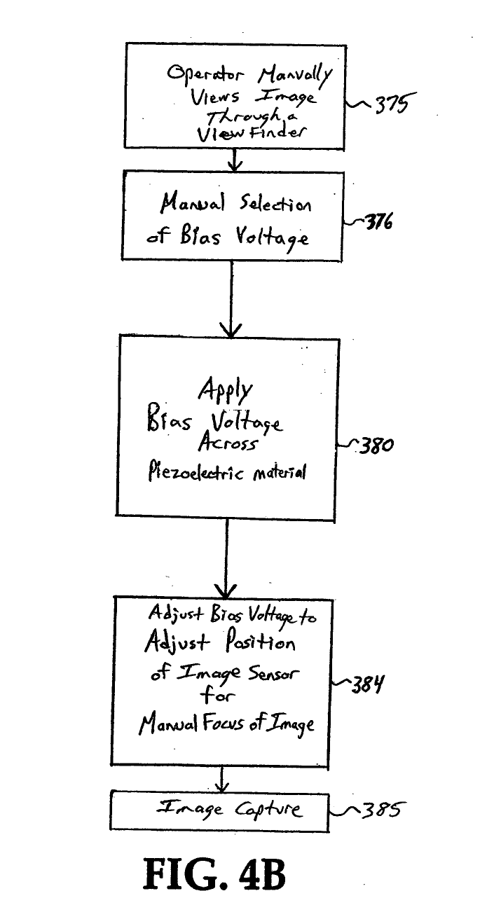

FIG. 4A is a flowchart of an automatic focus operation which may be used with the FIG. 3 exemplary embodiment of the invention. As shown in FIG. 4A, an image is first detected by an image sensor (300). The image sensor, for example image sensor 224, may be a component of any imaging device, such as a CMOS, CCD or other imaging device. The position of the image sensor is detected and stored in memory (304). The obtained image is processed using an image processor (308). Image processing may be performed according to any known image processing techniques. For example, image processing may comprise sampling of pixels in an image array according to one or more criteria, such as color processing, white balancing, or other criteria. In the embodiment shown in FIG. 4A, information on the position of the image sensor may be used with other information, such as the values of the pixels in the sample (not shown), in calculating whether the image is in focus and, thus, whether adjustment of the position of the image sensor is required for autofocus (312).

If adjustment of the image sensor is required for an autofocus operation (312), the image sensor may be elevated or lowered as needed according to one or more autofocus algorithms (316). As determined by one or more autofocus algorithms, a control voltage may be applied across a piezoelectric material from a voltage source. For example, the control voltage for regulating the piezoelectric material may be generated on the chip contacting the image sensor 224, as depicted schematically in FIG. 3A. The one or more autofocus algorithms regulate the bias voltage across the piezoelectric material (320) according to one or more autofocus criteria, such as image entropy. Regulation of the bias voltage across the piezoelectric material can be used to change the thickness of the piezoelectric material. As a result, the position of the image sensor 224 may be adjusted to bring an image into focus (324). After image processing (308), the same autofocus inquiry is made (312) and steps 316 through 324 may be repeated until autofocus is obtained. At this stage, the entire process may begin anew as a new image is obtained for autofocus.

FIG. 4B is a flowchart of a manual focus operation which may be used with the FIG. 3A exemplary embodiment of the invention. For a manual focus operation, manual focus occurs before image capture. An operator manually views an image through a viewfinder (375). To manually focus the image, the operator manually selects a bias voltage (376) which is applied to a piezoelectric material 226 (380). The operator then adjusts the bias voltage to change the thickness of piezoelectric material 226 and, accordingly, adjust the position of the image sensor 224 until the image is in focus (384). The image is then captured (385) for subsequent image processing.

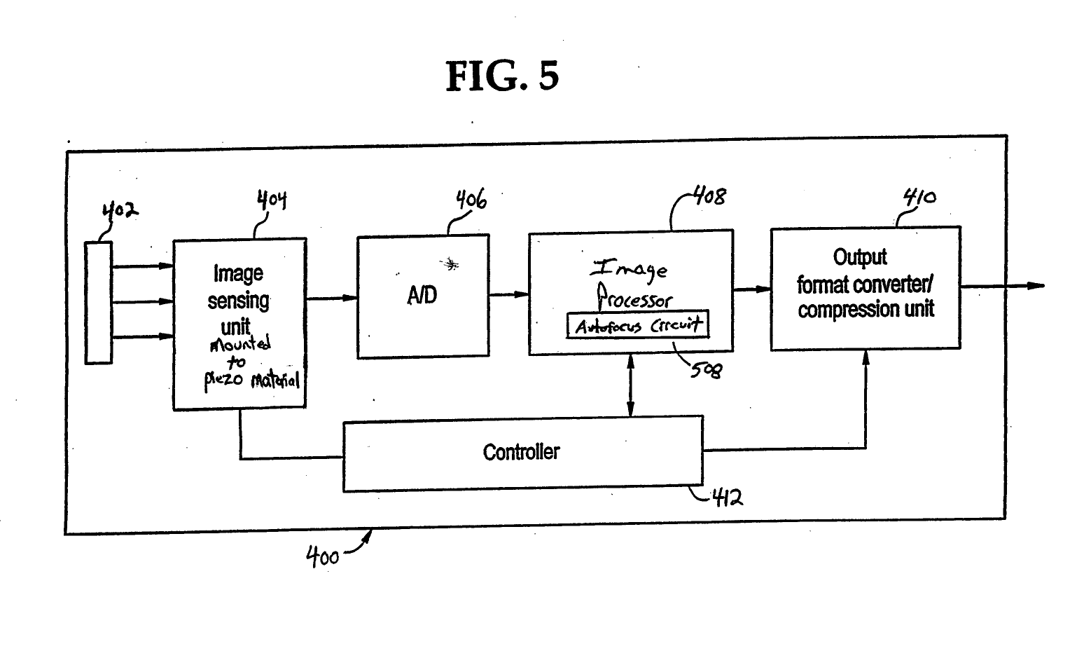

An exemplary embodiment of an imaging apparatus 400 incorporating features discussed above is shown in FIG. 5. FIG. 5 depicts imaging apparatus 400 that performs a focus operation, e.g. automatic focus, in accordance with an exemplary embodiment of the invention. Apparatus 400 includes a lens system 402 for directing light from an object to be imaged to image sensing unit 404. Image sensing unit 404 may comprise an image sensor further comprising a pixel array, wherein the image sensor is mounted over a piezoelectric material. Analog-to-digital converter 406 converts the analog image signals from image sensing unit 404 into digital signals. Image processor 408 performs image correction processes on the digital signals, including a focus operation, e.g. an autofocus operation (508), and other processes such as data correction for defective pixels, color interpolation, sharpness filtering, etc., in producing digital image data. Output format converter/compression unit 410 converts the digital image data into an appropriate file format for output or display to the user. Controller 412 controls the operations of the apparatus 400.

In one embodiment, an image sensor in the image sensing unit 404 is constructed as an integrated circuit (IC) that includes pixels having respective photosensors. The IC can include, as part of lens system 402, an array of microlenses over the pixels. The image sensor in unit 404 is mounted over a piezoelectric material, or any other device or mechanism that may be adjusted, and may be a complementary metal oxide semiconductor (CMOS) sensor, a charge coupled device (CCD) sensor, or other pixel imaging sensor. The IC can include AID converter 406, image processor 408, such as a CPU, digital signal processor or microprocessor, output format converter 410 and timing controller 412.

Without being limiting, such an imaging apparatus 400 could be part of a computer system, camera system, scanner, machine vision system, vehicle navigation system, video telephone, surveillance system, and other image processing systems.

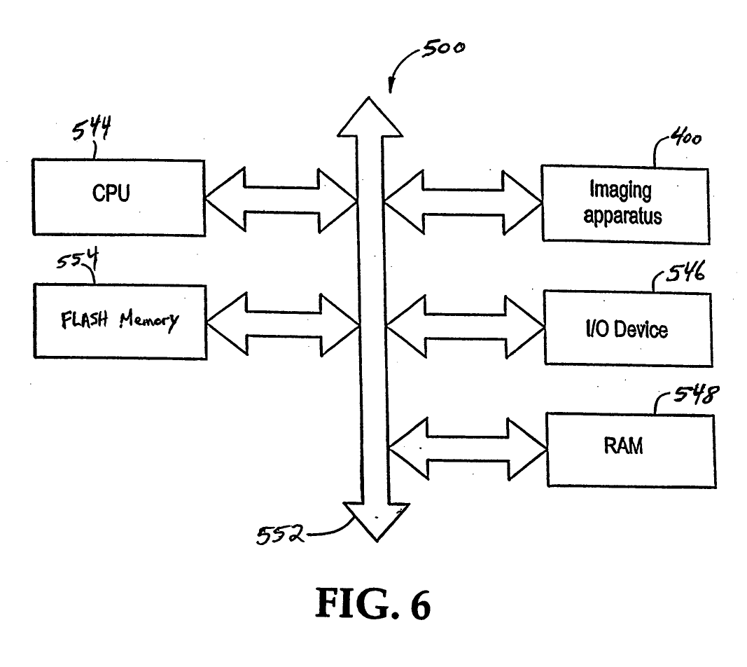

FIG. 6 shows an exemplary embodiment in which processor system 500, such as used, for example, in a digital camera system, includes an imaging apparatus 400 as in FIG. 5. System 500 includes a central processing unit (CPU) 544 that communicates with an input/output (I/O) device 546 over a bus 552. Apparatus 400 communicates with CPU 544 and other components of the system over bus 552 or a ported connection. System 500 also includes random access memory (RAM) 548 and may include peripheral devices such as a removable FLASH memory 554 which also communicates with CPU 544 over the bus 552. FLASH memory 554 may provide information storage in any type of imaging application, for example in digital cameras. Examples of FLASH memory 554 that may be used in the invention include, for example, removable solid-state storage devices such as memory cards.

The above description and drawings illustrate embodiments which achieve the objects of the present invention. Although certain advantages and embodiments have been described above, those skilled in the art will recognize that substitutions, additions, deletions, modifications and/or other changes may be made without departing from the spirit or scope of the invention. Accordingly, the invention is not limited by the foregoing description but is only limited by the scope of the appended claims.

What is claimed as new and desired to be protected by Letters Patent of the United States is:

1. A method of forming an imaging device, comprising:
coupling at least one image sensing unit to at least one moveable element such that said image sensing unit moves with a change in position of said at least one moveable element, said at least one image sensing unit comprising a pixel array, wherein a selective change in the position of said at least one moveable element produces a selective change in a position of said at least one image sensing unit; and
forming an electronic input for controlling a position of said at least one moveable element.

2. The method of claim 1, further comprising forming at least one optical device over said at least one image sensing unit, said at least one optical device maintaining a fixed mounted position.

3. The method of claim 1, further comprising connecting an autofocus circuit to said electronic input.

4. The method of claim 1, further comprising connecting a manual focus circuit to said electronic input.

5. The method of claim 1, wherein said at least one moveable element comprises at least one piezoelectric material.

6. The method of claim 1, wherein said imaging device is a CMOS imaging device.

7. The method of claim 1, wherein said imaging device is a CCD imaging device.

8. A method of operating an imaging device, comprising:
changing at least a position of at least one moveable element over a substrate; and
changing at least a position of at least one image sensing unit in response to said changing at least a position of said at least one moveable element, said at least one image sensing unit comprising a pixel array.

9. The method of claim 8, wherein said changing at least a position of said at least one moveable element further comprises controlling said at least one moveable element by manual or automatic input.

10. The method of claim 9, wherein said changing at least a position of said at least one moveable element occurs in response to an automatic input.

11. The method of claim 9, wherein said changing at least a position of said at least one moveable element occurs in response to a manual input.

12. The method of claim 8, wherein said at least one moveable element comprises at least one piezoelectric material.

13. The method of claim 12, wherein a selective change in at least a position of said at least one piezoelectric material moves said at least one image sensing unit relative to a fixed position lens.

14. The method of claim 8, wherein said changing at least a position of said at least one moveable element comprises application of a voltage to said at least one moveable element.

15. The method of claim 14, wherein the voltage applied to said at least one moveable element is obtained from at least one conductor of an imaging device.

16. The method of claim 14, wherein the voltage applied to said at least one moveable element is obtained from at least one external voltage source.

17. The method of claim 10, wherein said changing at least a position of said at least one moveable element occurs in response to at least one autofocus algorithm.

18. The method of claim 17, wherein said at least one autofocus algorithm is based on one or more image entropy criteria.

19. The method of claim 18, wherein said one or more image entropy criteria comprises regional entropy maximization.

20. The method of claim 18, wherein said one or more image entropy criteria is applied to each pixel to determine whether a substantially focused image is rendered.

21. The method of claim 8, wherein said imaging device is a CMOS imaging device.

22. The method of claim 8, wherein said imaging device is a CCD imaging device.

23. The method of claim 8, wherein said changing at least a position of at least one image sensing unit produces a substantially focused image.

24. The method of claim 8, wherein said changing at least a position of at least one image sensing unit occurs while maintaining a fixed-position lens mount.

25. The method of claim 24, wherein the fixed-position lens mount comprises a double biconvex lens.

26. The method of claim 24, wherein the fixed-position lens mount comprises a substantially spherical lens.

27. A method of forming an imaging device, comprising:
providing at least one moveable element over a substrate, wherein at least a position of said at least one moveable element may be selectively changed in response to manual or automatic input; and
coupling at least one image sensing unit to said at least one moveable element such that said image sensing unit moves with a change in position of said at least one moveable element, said at least one image sensing unit comprising a pixel array, wherein a selective change in the position of said at least one moveable element produces a selective change in a position of said at least one image sensing unit;
forming an electronic input for controlling a position of said at least one moveable element; and
forming at least one optical device over said at least one image sensing unit, said at least one optical device maintaining a fixed mounted position.

28. The method of claim 27, further comprising connecting an autofocus circuit to said electronic input.

29. The method of claim 27, further comprising connecting a manual focus circuit to said electronic input.

30. The method of claim 27, wherein said at least one moveable element comprises at least one piezoelectric material.

31. The method of claim 27, wherein said imaging device is a CMOS imaging device.

32. The method of claim 27, wherein said imaging device is a CCD imaging device.

33. A method of forming an imaging device, comprising:
providing at least one piezoelectric material within a mounting structure, wherein at least a position of said at least one piezoelectric material may be selectively changed in response to manual or automatic input; and
coupling at least one image sensing unit to said at least one piezoelectric material such that said image sensing unit moves with a change in position of said at least one piezoelectric material, said at least one image sensing unit comprising a pixel array, wherein a selective change in the position of said at least one piezoelectric material produces a selective change in a position of said at least one image sensing unit; and
forming an electronic input for controlling a position of said at least one piezoelectric material.

34. The method of claim 33, wherein a change in position of said at least one piezoelectric material occurs in response to an automatic input.

35. The method of claim 33, wherein a change in position of said at least one piezoelectric material occurs in response to a manual input.

36. A method of adjusting the focus of an image, comprising:
receiving said image by at least one image sensing unit comprising a pixel array;
determining whether the image received at said at least one image sensing unit is substantially in focus; and
adjusting the position of said at least one image sensing unit if the image is not substantially in focus to bring the image substantially into focus.

37. The method of claim 36, wherein said adjusting the position of said at least one image sensing unit comprises at least one automatic operation.

38. The method of claim 36, wherein said adjusting the position of said at least one image sensing unit comprises at least one manual operation.

39. The method of claim 36, wherein said position adjusting is performed by at least one moveable element which moves said at least one image sensing unit relative to a fixed mounted lens which provides said image to said at least one image sensing unit.

40. The method of claim 36, wherein said determining and adjusting acts depends on at least one autofocus algorithm.

41. The method of claim 39, wherein said at least one moveable element comprises at least one piezoelectric material.

42. The method of claim 39, wherein said position adjusting further comprises applying an electronic input to said at least one moveable element.

43. The method of claim 42, wherein said electronic input is obtained from at least one conductor of an imaging device.

44. The method of claim 42, wherein said electronic input is obtained from at least one external voltage source.

45. The method of claim 40, wherein said at least one autofocus algorithm is based on one or more image entropy criteria.

46. The method of claim 45, wherein said one or more image entropy criteria comprises regional entropy maximization.

47. The method of claim 45, wherein said one or more image entropy criteria is applied to each pixel.

48. The method of claim 36, wherein said at least one image sensing unit comprises a CMOS image sensing unit.

49. The method of claim 36, wherein said at least one image sensing unit comprises a CCD image sensing unit.

50. The method of claim 36, wherein bringing the image substantially into focus is performed while maintaining a fixed-position lens mount.

51. The method of claim 50, wherein the fixed-position lens mount comprises a double biconvex lens.

52. The method of claim 50, wherein the fixed-position lens mount comprises a substantially spherical lens.

53. A method of forming an image sensing unit, comprising:
mounting an image sensor unit containing a pixel array to at least one piezoelectric material; and
mounting said image sensor unit and said at least one piezoelectric material in a housing having a lens assembly such that said lens assembly directs an image onto said image sensor unit.

54. The method of claim 53, wherein the position of said image sensor unit and said at least one piezoelectric material is selectively adjusted to substantially focus said image.

55. The method of claim 53, wherein the position of said image sensor unit and said at least one piezoelectric material is determined by at least one autofocus algorithm.

56. The method of claim 55, wherein said at least one autofocus algorithm is based on one or more image entropy criteria.

57. The method of claim 56, wherein said one or more image entropy criteria comprises regional entropy maximization.

58. The method of claim 56, wherein said one or more image entropy criteria is applied to each pixel.

59. The method of claim 54, wherein the position of said at least one piezoelectric material is selectively adjusted by applying a voltage to said at least one piezoelectric material.

60. The method of claim 59, wherein the voltage applied to said at least one piezoelectric material is obtained from at least one conductor of an imaging device.

61. The method of claim 59, wherein the voltage applied to said at least one piezoelectric material is obtained from at least one external voltage source.

62. The method of claim 53, wherein said image sensor unit is a CMOS image sensor unit.

63. The method of claim 53, wherein said image sensor unit is a CCD image sensor unit.

64. The method of claim 53, wherein said lens assembly comprises a fixed-position lens mount.

65. The method of claim 64 wherein the fixed-position lens mount comprises a double biconvex lens.

66. The method of claim 64 wherein the fixed-position lens mount comprises a substantially spherical lens.

67. A method of forming an imaging device, comprising:
forming at least one moveable element over a substrate, wherein at least a position of said at least one moveable element may be selectively changed in response to manual or automatic input; and
coupling at least one image sensing unit to said at least one moveable element such that said image sensing unit moves with a change in position of said at least one moveable element, said at least one image sensing unit comprising a pixel array, wherein a selective change in the position of said at least one moveable element produces a selective change in a position of said at least one image sensing unit; and
forming an electronic input for controlling a position of said at least one moveable element.

68. The method of claim 1, further comprising forming at least one optical device over said at least one image sensing unit, said at least one optical device maintaining a fixed mounted position.

69. The method of claim 1, further comprising connecting an autofocus circuit to said electronic input.

70. The method of claim 1, further comprising connecting a manual focus circuit to said electronic input.

71. The method of claim 1, wherein said at least one moveable element comprises at least one piezoelectric material.

72. The method of claim 1, wherein said imaging device is a CMOS imaging device.

73. The method of claim 1, wherein said imaging device is a CCD imaging device.

74. An image sensing unit, comprising:
at least one moveable element; and
at least one image sensing unit coupled to said at least one moveable element to be moveable with said moveable element, said at least one image sensing unit comprising a pixel array; and
an electronic input for controlling a position of said at least one moveable element.

75. The image sensing unit of claim 74, further comprising at least one fixed position optical device over said at least one image sensing unit.

76. The image sensing unit of claim 74, further comprising an autofocus circuit connected to said electronic input.

77. The image sensing unit of claim 74, further comprising a manual focus circuit connected to said electronic input.

78. The image sensing unit of claim 74, wherein said at least one moveable element comprises at least one piezoelectric material.

79. The image sensing unit of claim 74, wherein said image sensing unit is a CMOS image sensing unit.

80. The image sensing unit of claim 74, wherein said image sensing unit is a CCD image sensing unit.

81. An apparatus for performing an image focus operation, comprising:
a first means for causing a processor to use a value of each pixel in an image to determine whether the image detected by an image sensor unit is substantially in focus, said image sensor unit containing a pixel array; and
a second means for adjusting the position of said image sensor unit by regulating at least a position of at least one moveable element mounted to said image sensor unit to bring the image substantially into focus.

82. An image processor comprising a focusing circuit that regulates the focus of an image, in response to automatic or manual input, by changing at least a position of at least one moveable element such that the position of an image sensor unit is changed to bring the image substantially into focus, wherein said image sensor unit is coupled to said at least one moveable element.

83. The image processor of claim 81, wherein said at least one moveable element is a piezoelectric material.

84. The image processor of claim 81, wherein the image sensor unit is a CMOS image sensor unit.

85. The image processor of claim 81, wherein the image sensor unit is a CCD image sensor unit.

86. An image processing apparatus comprising:
an image sensor unit for receiving an image and outputting an image signal that includes pixel data for each pixel of the image; and
an image processor for processing the image signal, the image processor comprising a focusing circuit that regulates the focus of the image, by changing at least a position of at least one moveable element such that the position of the image sensor unit is changed in a corresponding manner to bring the image substantially into focus, wherein said image sensor unit is coupled to said at least one moveable element.

87. The image processing apparatus of claim 86, wherein said at least one moveable element is a piezoelectric material.

88. The image processing apparatus of claim 86, wherein the image sensor unit is a CMOS image sensor unit.

89. The image processing apparatus of claim 86, wherein the image sensor unit is a CCD image sensor unit.

90. A processing system, comprising:
a processor; and
an imaging apparatus that provides image data to the processor, the imaging apparatus comprising
an image sensing unit for receiving an image and outputting an image signal which includes pixel image data for each line of the image; and
an image processor for processing the image signal, the image processor comprising a focusing circuit that regulates the focus of the image, by changing at least a position of at least one moveable element such that the position of the image sensor unit is changed in a corresponding manner to bring the image substantially into focus, wherein said image sensor unit is coupled to said at least one moveable element.

91. The processing system of claim 90, wherein said at least one moveable element is a piezoelectric material.

92. The processing system of claim 90, wherein the image sensor unit is a CMOS image sensor unit.

93. The processing system of claim 90, wherein the image sensor unit is a CCD image sensor unit.
